(19) United States
(12) Patent Application Publication
(10) Pub. No.: US 2014/0187371 A1
(43) Pub. Date: Jul. 3, 2014

(54) CHAIN GUIDE MEMBER

(71) Applicant: HYUNDAI MOTOR COMPANY, Seoul (KR)

(72) Inventor: Min Yong Lee, Bucheon-si (KR)

(73) Assignee: Hyundai Motor Company, Seoul (KR)

(21) Appl. No.: 13/856,208

(22) Filed: Apr. 3, 2013

(30) Foreign Application Priority Data
Dec. 28, 2012 (KR) 10-2012-0156291

(51) Int. Cl. F16H 7/18

(52) U.S. Cl. CPC F16H 7/18
USPC 474/140

(57) ABSTRACT

A chain guide member may include a base portion forming a body of a chain guide member and a protruding portion protruding from the base portion and configured to be in contact with a circumferential surface of a roller of a chain.

### CROSS-REFERENCE TO RELATED APPLICATION

The present application claims priority to Korean Patent Application No. 10-2012-0156291, filed on Dec. 28, 2012, the entire contents of which is incorporated herein for all purposes by this reference.

### BACKGROUND OF THE INVENTION

1. Field of the Invention

The present invention relates to a chain guide member intended to guide a moving course of a chain that is a power transmission element and, more particularly, to a structure of a chain guide member.

2. Description of the Related Art

An engine for a vehicle often uses a chain as a power transmission element. Particularly, in order to secure durability while precisely transmitting a rotating force from a crankshaft of the engine to a camshaft, a power transmission configuration using a chain is widely used.

FIG. 1 illustrates an example wherein a conventional chain of an engine is installed. This is provided with a first chain 500 for driving a camshaft, and a second chain 502 for driving a balance shaft and an oil pump. A guide member, that is, a chain guide 504 and a chain arm 506 are installed to maintain the tension of each of the first and second chains 500 and 502 and to guide a moving course thereof. The chain arm 506 is supported by a tensioner 508.

As a chain, a roller chain that has a roller on a central portion thereof so as to reduce friction between a cam sprocket and a crank sprocket is used. FIGS. 2 and 3 illustrate a state in which a chain 510 using the above-mentioned roller 516 is in contact with a guide member 512. The guide member 512 is configured to come into contact with a link 514 of the chain.

Thus, when the chain 510 passes through the sprocket by the roller 516 provided on the central portion thereof, a rolling contact is generated to reduce a frictional force. However, while the chain 510 is passing through the guide member 512, it is in sliding contact with the link 514 regardless of whether the roller 516 is present or not, thus having a limit to reduce the frictional force. Furthermore, in order to reduce the frictional force, the roughness of a contact surface should be improved in the machining of the chain link 514. As such, the conventional chain is disadvantageous in terms of productivity and manufacturing cost.

The information disclosed in this Background of the Invention section is only for enhancement of understanding of the general background of the invention and should not be taken as an acknowledgement or any form of suggestion that this information forms the prior art already known to a person skilled in the art.

### SUMMARY OF THE INVENTION

Various aspects of the present invention are directed to providing a chain guide member intended to guide a chain having a roller, which is improved in structure to considerably reduce a loss of friction between the chain and the guide member, thus increasing power transmitting efficiency of the chain, enhancing fuel efficiency of an engine using the chain, and eliminating unnecessary efforts to improve the roughness of a link of the chain, and thereby increasing productivity and decreasing manufacturing cost of the chain.

In an aspect of the present invention, a chain guide member may include a base portion forming a body of a chain guide member, and a protruding portion protruding from the base portion and configured to be in contact with a circumferential surface of a roller of a chain.

The protruding portion is in a stepped shape that protrudes continuously along a longitudinal direction of the chain guide member, and wherein a predetermined region of the protruding portion contacting the roller of the chain may have a straight cross-section, so that the protruding portion is in line contact with the roller.

The protruding portion protrudes at a predetermined height from the base portion to allow the base portion to be spaced apart from a link of the chain as the protruding portion comes into contact with the roller of the chain.

A width of the protruding portion is formed to be less than a width of the roller, thus preventing the protruding portion from being in contact with the link of the chain.

A height of the protruding portion is not less than 0.3% of a distance from a center of the roller to an end of the link.

The protruding portion is in a stepped shape that protrudes continuously along a longitudinal direction of the guide member, wherein a predetermined region of the protruding portion contacting the roller of the chain may have an arc-shaped cross-section convexly-protruding towards the roller.

Links are pivotally coupled to both ends of the roller, wherein the protruding portion is disposed between the links onto the roller.

As described above, the present invention provides a chain guide member intended to guide a chain having a roller, which is improved in structure to considerably reduce a loss of friction between the chain and the guide member, thus increasing power transmitting efficiency of the chain, enhancing fuel efficiency of an engine using the chain, and eliminating unnecessary efforts to improve the roughness of a link of the chain, and thereby increasing productivity and decreasing manufacturing cost of the chain.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a conventional chain system for an engine.

FIG. 2 is a view illustrating a roller chain and a chain guide member used in a conventional engine.

FIG. 3 is a sectional view of FIG. 2.

FIG. 4 is a view illustrating a chain guide member according to an exemplary embodiment of the present invention, together with a roller chain.

FIG. 5 is a sectional view of FIG. 4.

FIG. 6 is a sectional view illustrating a state in which the guide member of the present invention is spaced apart from the chain.

FIG. 7 is a view illustrating another embodiment of the present invention.

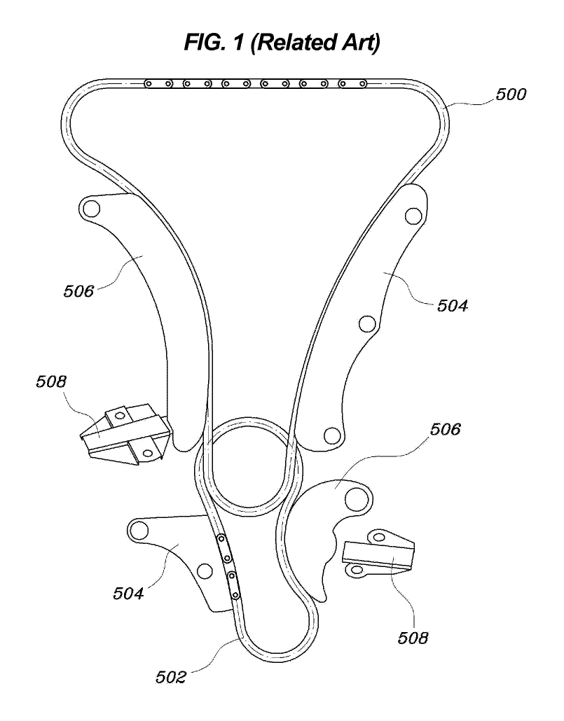

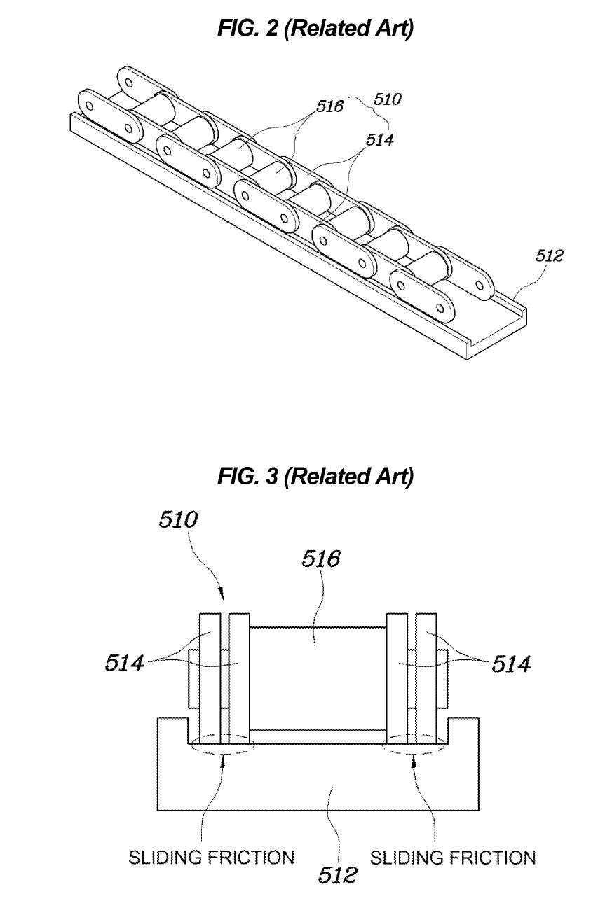

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

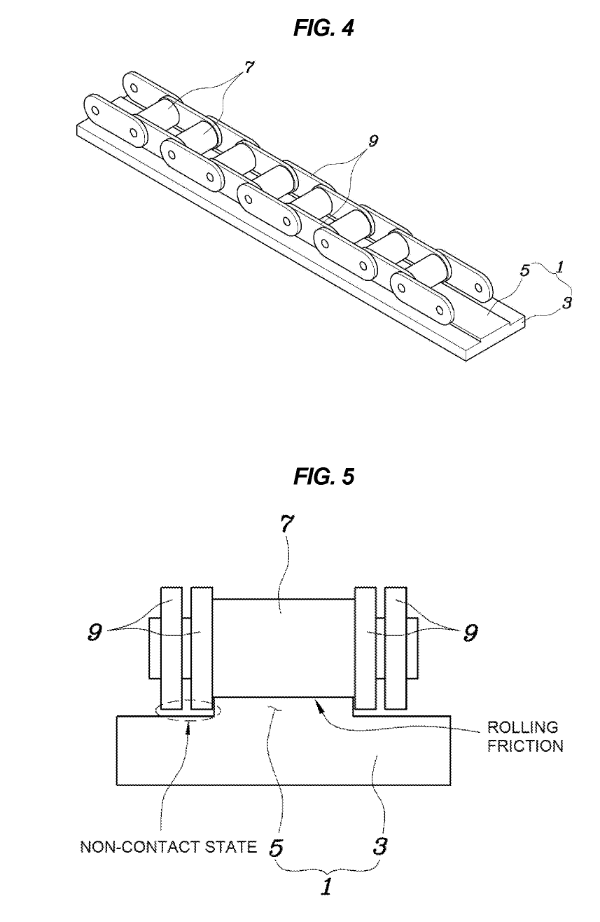

Referring to FIGS. 4 and 5, a chain guide member according to an exemplary embodiment of the present invention includes a base portion 3 that forms a body of a chain guide member 1, and a protruding portion 5 that protrudes from the base portion 3 in such a way as to be in contact with a circumferential surface of a roller of a chain.

In other words, the chain guide member guides the movement of the chain while only the protruding portion 5 protruding from the base portion 3 is in contact with the roller 7 of the chain, but the base portion 3 of the guide member 1 is not in direct contact with the chain. Thereby, the movement of the chain is guided with the roller 7 being in rolling contact with the protruding portion 5. Therefore, as compared to the conventional configuration wherein the link comes into contact with the guide member 1 to generate a frictional force, the frictional force is remarkably reduced, so that power transmission efficiency can be improved.

The protruding portion 5 includes a protruding step that protrudes continuously and lengthily in a longitudinal direction of the guide member 1. A predetermined region of the protruding portion 5 contacting the roller 7 of the chain has a straight cross-section, so that the protruding portion 5 is in line contact with the roller 7.

Of course, the protruding portion 5 protrudes at a predetermined height to allow the base portion 3 to be spaced apart from the link 9 of the chain as the protruding portion 5 comes into contact with the chain. A width of the protruding portion 5 is formed to be less than a width of the roller 7, thus preventing the protruding portion 5 from being in contact with the link 9 of the chain.

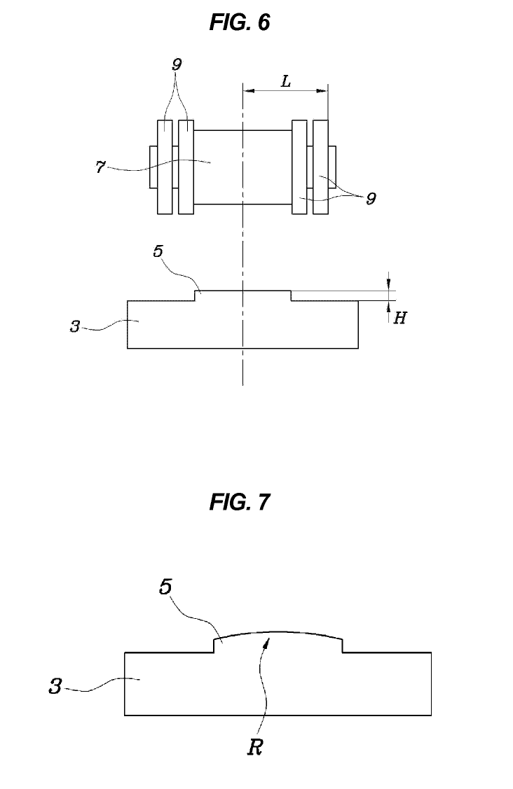

Further, as shown in FIG. 6, the height H of the protruding portion 5 is not less than 0.3% of a distance from a center of the roller 7 to an end of the link 9.

That is, the above-mentioned height prevents the link 9 of the chain from coming into contact with the base portion 3 of the guide member even if the chain tilts relative to the guide member, thus completely preventing a frictional force from being generated due to the contact of the link 9 with the base portion 3.

Thus, the link 9 of the chain is not in contact with any portion of the guide member 1, and only the roller is guided by the protruding portion 5 of the guide member 1. As a result, unlike the related art, it is unnecessary to machine the link 9 of the chain so that its surface roughness is very precise so as to reduce the frictional force. Therefore, the productivity of the chain can be increased and the manufacturing cost thereof can be reduced.

Further, FIG. 7 shows another embodiment of the present invention. According to this embodiment, a predetermined region of the protruding portion 5 contacting the roller 7 of the chain has an arc-shaped cross-section. In other words, as shown in the drawing, the protruding portion 5 of the guide member 1 may be formed in an arc or barrel shape wherein a central region thereof is convex towards the roller 7 of the chain. Of course, likewise, in this case, the link 9 of the chain is not in contact with any portion of the guide member 1, and only the roller is guided by the protruding portion 5 of the guide member 1.

Preferably, the protruding portion 5 has a very large curvature radius in such a way that the arc of the protruding portion 5 meets the roller 7 in an almost straight line. Such a curvature radius is designated by reference symbol R in FIG. 7.

An engine with a chain power transmission structure using the chain guide member 1 constructed as described above reduces a frictional loss occurring while the chain is driving, according to the above-mentioned principle, thus contributing to improve the fuel efficiency of the engine.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A chain guide member, comprising:
a base portion forming a body of a chain guide member; and
a protruding portion protruding from the base portion and configured to be in contact with a circumferential surface of a roller of a chain.

2. The chain guide member as set forth in claim 1,
wherein the protruding portion is in a stepped shape that protrudes continuously along a longitudinal direction of the chain guide member, and
wherein a predetermined region of the protruding portion contacting the roller of the chain has a straight cross-section, so that the protruding portion is in line contact with the roller.

3. The chain guide member as set forth in claim 1, wherein the protruding portion protrudes at a predetermined height from the base portion to allow the base portion to be spaced apart from a link of the chain as the protruding portion comes into contact with the roller of the chain.

4. The chain guide member as set forth in claim 1, wherein a width of the protruding portion is formed to be less than a width of the roller, thus preventing the protruding portion from being in contact with the link of the chain.

5. The chain guide member as set forth in claim 1, wherein a height of the protruding portion is not less than 0.3% of a distance from a center of the roller to an end of the link.

6. The chain guide member as set forth in claim 1,
wherein the protruding portion is in a stepped shape that protrudes continuously along a longitudinal direction of the guide member, and
wherein a predetermined region of the protruding portion contacting the roller of the chain has an arc-shaped cross-section convexly-protruding towards the roller.

7. The chain guide member as set forth in claim 1,
wherein links are pivotally coupled to both ends of the roller, and
wherein the protruding portion is disposed between the links onto the roller.

8. An engine for a vehicle having a chain power transmission structure using the chain guide member according to claim 1.
